(19) United States
(12) Patent Application Publication
(10) Pub. No.: US 2026/0258882 A1
(43) Pub. Date: Sep. 3, 2026

(54) Relief Valve

(71) Applicant: LEINEMANN GMBH & CO. KG, Braunschweig (DE)

(72) Inventor: Ralf Kosmehl, Lehrte (DE)

(21) Appl. No.: 19/403,390

(22) Filed: Nov. 28, 2025

(30) Foreign Application Priority Data
Dec. 2, 2024 (DE) 10 2024 135 636.7

(51) Int. Cl. F16K 35/02; F16K 17/04

(52) U.S. Cl. CPC F16K 35/025; F16K 17/0413

(57) ABSTRACT

A relief valve has a valve seat and a valve disc. The valve disc can be brought into a first position in which it is in contact with the valve seat and the relief valve is closed. The valve disc can be brought into a second position in which the relief valve is open. There is at least one locking element, at least one spring element, and at least one recess. The at least one locking element is held in the at least one recess by the at least one spring element when the valve disc is in the first position and is moved out of the at least one recess against a force applied by the spring element when the valve disc is brought from the first position into the second position.

### FIELD OF THE INVENTION

The invention relates to a relief valve with a valve seat and a valve disc, which can be brought into a first position, in which it is in contact with the valve seat and the valve is closed, and into a second position in which the valve is open.

### BACKGROUND

Within the meaning of the present invention, a relief valve is a valve that is connected to a container in such a way that a pressure prevailing inside the container acts directly or indirectly on the valve disc of the relief valve. Such a container is, for example, a tank, a reactor, a pipeline or pipe or another kind of container in which a substance, in particular a gas or gas mixture, is found. There are numerous situations in which the pressure inside the container may increase, for example an increase in temperature, which causes the substance inside the container to expand. This increase in pressure may mean that the container can no longer withstand the pressure when a pressure limit is reached, causing it to yield. On the one hand, this destroys the container and, on the other hand, allows the content of the container to escape uncontrollably. Depending on the substance stored in the container, this may result in significant danger to the surrounding environment.

### SUMMARY

A relief valve within the meaning of the present invention is configured in such a way that the valve disc is brought from the first position, in which the valve is closed, in a self-acting manner into the second position when the pressure difference between the side of the valve disc facing the container, on which the pressure inside the container is acting, and the opposite side facing away from the container, exceeds a predetermined value. This predetermined value is referred to as response pressure as the relief valve responds to this pressure and opens in a self-acting manner. In this case, the term self-acting means that the influence of a human operator or electric control unit, such as an electronic data processing device, is not necessary and that no such influence occurs. In particular, it is unnecessary for a sensor to measure the pressure in the container; for the measurement data to be transmitted to an electric control unit; and for this control unit to then send control signals to the valve in order to move the valve disc out of the first position into the second position by means of an actuator provided for this purpose.

In the present case, self-acting means that the movement of the valve disc is caused by the pressure difference; the pressure difference between the pressures acting on both sides of the valve disc provides the force required to move the valve disc.

Within the meaning on the present invention, a relief valve is therefore brought from the closed state into the open state when the pressure difference between the two pressures acting on the opposite sides of the valve disc exceeds a predetermined value. As a result of the pressure difference, a force is then applied to the valve disc that moves it out of the first position and into the second position. In this case, it is irrelevant whether this pressure difference is reached by increasing the pressure on one side of the valve disc or the pressure on the opposite side is reduced. It is only important that the valve disc has a “high-pressure side” that the higher pressure acts on and a “low-pressure side” that the lower pressure acts on.

In a first application of such a relief valve, the relief valve is connected to a container in such a way that the high-pressure side of the valve disc faces the interior of the container. The valve then acts as protection against too high a pressure in the interior of the container. By opening the valve when the response pressure is reached, material is released from the container and the pressure inside the container decreases.

In a second application of such a relief valve, the relief valve is connected to the container in such a way that the low-pressure side faces the interior of the container. The valve then acts as protection against too low a pressure in the interior of the container. By opening the valve when the response pressure is reached, material is sucked into the container and the pressure inside the container increases. In this case, one could also refer to a “vacuum valve”.

Such relief valves have been known from the prior art for many years and are known in various embodiments. They all comprise a valve disc on which a force acts, said force having to be overcome by the force generated by the pressure difference in order to bring the valve disc from the first position into the second position, thereby bringing the valve from the closed state into the open state. This force can be generated by the weight force acting on the valve disc and any spring elements provided such that it can be adjusted by way of the construction of the valve disc and spring elements.

Relief valves are constructed for a range of applications. On the one hand, this refers to the environmental conditions under which they are operated, such as ambient temperatures and humidity as well as the pressures and substances they have to withstand. On the other hand, a range of demands are placed on their behavior. For example, there are relief valves that may also be referred to a switch valves, the valve disc of which is specially formed at the edge so as to enable the quickest possible opening and, where necessary, closing. It is particularly important to consider whether a relief valve is expected to respond frequently, i.e. be opened, for its intended purpose. In some applications, the relief valve is an emergency valve that should not respond during normal operation of the system of which it is a part. In these applications, it can take years for the emergency to occur which causes the valve to respond and move it into the open state. The relief valve must also work in this case. In particular, corrosion and other environmental influences must not have restricted the movement of the valve disc. At the same time, the response pressure must not have changed during this time, for example because elastically pre-tensioned elements have relaxed, causing an originally elastic deformation to have transitioned into a plastic deformation. A reduction in the response pressure would result in a premature and therefore unnecessary response. An increase in the response pressure would mean that the relief valve responds too late or, in the worst case, not at all.

For such requirements, for which the relief valve is unlikely to respond for an extended period of time but does have to work safely, so-called “pin tech” methods have been developed. The valve disc is held in the first position by a rod or pin.

When the response pressure is reached, this rod or pin is bent and the valve disc can be moved by the pressure difference. The disadvantage is that this valve cannot be closed again or reused without at least exchanging the rod or pin and replacing it with an intact rod or pin. As a result, the efforts required for maintenance are high in the event of it responding.

The invention therefore aims to further develop a relief valve in such a way that it still works reliably, even after an extended period of time, and can be reused and closed again more easily.

The invention solves the task addressed by way of a relief valve, which is characterized in that the relief valve comprises at least one locking element, at least one spring element and at least one recess, wherein the at least one locking element is held in the at least one recess by the at least one spring element when the valve disc is held in the first position and moved out of the at least one recess against a force applied by the spring element when the valve disc is brought from the first position into the second position.

Therefore, in order to be moved from the first position into the second position, the valve disc of the relief valve according to the invention has to overcome the force exerted by the at least one spring element with which the at least one locking element is held in the at least one recess. In order to move the valve disc of the relief valve according to the invention out of the first position into the second position, the at least one locking element has to be moved out of the least one recess against a force applied by the at least one spring element. In one preferred embodiment, the force exerted by the spring element is not directed in the opposite direction to the direction of movement of the valve disc; rather, the direction of the force forms an angle, particularly preferably a 90° angle, with the direction of movement of the valve disc.

For example, if a relief valve is arranged such that the valve disc has to be displaced upwards, i.e. against the force of gravity, in order to move it out of the first position and into the second position, the force exerted by the at least one spring element is in a direction that does not extend vertically, but at an angle, particularly preferably horizontally.

The force acting on the valve disc due to the difference in pressure between the two sides of the valve disc is preferably directed along the direction of movement of the valve disc. This means that at least one part of this force has to be redirected in the direction of the force exerted by the at least one spring element.

This is preferably achieved by way of the point of contact between the at least one locking element and the recess, for example a side wall and/or the base of the recess. Depending on the angle of the surface on which this point of contact lies, the proportion of the force acting in the movement of direction of the valve disc that is redirected in the direction of the force generated by the spring element can be changed.

The force of the spring element that has to be overcome to open the relief valve and the force acting on the valve disc due to the pressure difference do not run parallel and only one part of the force acting on the valve disc is redirected. As a result, the force generated by the spring element is smaller than the force that corresponds to the response pressure. At the same response pressure, the force of the spring element and thus the spring element itself can be made smaller. The mechanical stresses of the elastic components, especially of the spring element, are therefore small and the risk of them leading to a plastic deformation of the spring element over time is likewise low.

As soon as the at least one locking element has been moved out of the recess, the valve disc can move and be displaced into the second position. By the at least one locking element, there is possibly another force acting on the valve disc because the locking element is still being pushed by the spring element towards the recess; however, this only leads to a force being applied to the valve disc that no longer significantly opposes the movement. From the moment that the locking element is moved out of the recess, the force opposing the movement of the valve disc is reduced and the valve disc is displaced particularly quickly from the first position into the second position and the relief valve opened.

Preferably, the relief valve comprises multiple, preferably two, three or four, locking elements; multiple, preferably two, three or four, spring elements; and multiple, preferably two, three or four, recesses. Multiple locking elements allow the force exerted by the spring elements, which opposes the movement of the valve disc until the response pressure is reached, to be distributed more effectively across the valve disc. Particularly where the force generated by the spring element does not extend parallel to the direction of movement of the valve disc, multiple spring elements and multiple locking elements enable the forces generated by the spring elements to mutually compensate each other, at least in a direction perpendicular to the direction of movement of the valve disc, particularly preferably in every direction perpendicular to the direction of movement of the valve disc.

Preferably at least one locking element, particularly preferably every locking element, comprises a pin, bolt and/or a ball. In one preferred embodiment, at least one locking element, but preferably each locking element, is a pin, bolt and/or a ball.

Advantageously, at least one locking element, but preferably each locking element, is made of a metal, such as steel or aluminum, or a ceramic. It has been proven advantageous if all locking elements are designed to be the same, both in shape and size as well as in terms of the material they are made from.

Preferably a projection, such as a valve spindle, a bar, a rod or a pin, is arranged on the valve disc, which can be moved in a guide of the relief valve by the valve disc being brought from the first position into the second position or vice versa. In one embodiment that is structurally particularly simple, the projection extends upwards starting from the valve disc, i.e. away from the side of the valve disc facing the container. The projection is detachably connected to the valve disc, for example it is screwed on or screwed into it. Alternatively, the projection is connected to the valve disc such that it cannot be detached, for example riveted, welded or designed as a single piece with the valve disc.

Advantageously, the at least one recess is arranged on the projection and the at least one spring element on the guide. Particularly preferably, the at least one recess is a groove in which multiple locking elements are held when the valve disc is in the first position. The locking element rests against at least one side wall and/or the base of the groove when the valve disc is in the first position.

The at least one locking element preferably protrudes into the recess when it is held in the recess. Therefore, the locking element does not have to be entirely in the recess - it is sufficient for it to protrude into it.

In one preferred embodiment, the relief valve comprises an energy store where energy is stored when the valve disc is moved from the first position into the second position. This energy store is, for example, an elastic element, such as a spring element, an elastomer element and/or a pneumatic element. When the valve disc opens upon reaching the response pressure, it preferably moves rapidly from the first position into the second position. There, it is slowed down and the energy it loses in the process is stored in the energy store. The energy store preferably comprises a release device. If this release device, which can also be referred to as an actuation element, is actuated, at least part of the stored energy, but preferably all of the stored energy, is released and acts on the valve disc in such a way that it is moved back out of the second position into the first position.

The release device preferably has an actuation element that can be actuated manually and/or by an electric control unit. The electric control unit can, but does not have to, constitute part of the relief valve.

### DESCRIPTION OF THE DRAWINGS

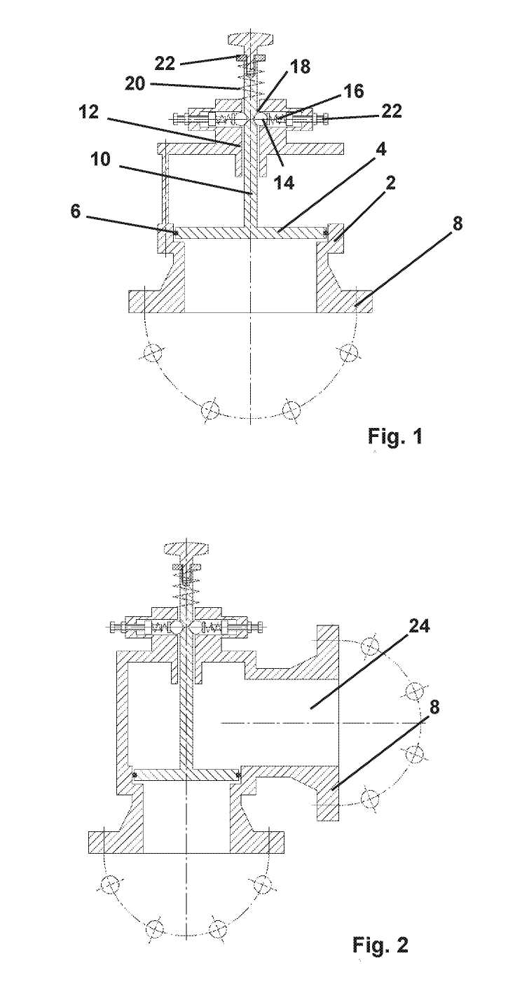

In the following, a number of embodiment examples of the invention will be explained in more detail with the aid of the accompanying figures. FIGS. 1 to 13 show schematic sectional views through a relief valve according to various embodiments of the present invention.

### DETAILED DESCRIPTION

FIG. 1 depicts a cut through a relief valve according to one embodiment example of the present invention. It has a valve seat 2 and a valve disc 4, which is in the first position in the illustration shown in which it rests on the valve seat 2. A sealing ring 6 is arranged on the valve disc that seals the area between the valve disc 4 and the valve seat 2. The relief valve shown has a flange 8, by means of which it can be attached to a container. The valve disc has a projection 10 which, in the embodiment example shown, is designed as a valve spindle and can be moved in a guide 12.

In FIG. 1, the valve disc 4 is in its first position, i.e. the relief valve is closed. In order to move the valve disc 4 into its second position, the valve disc 4 in FIG. 1 is moved upwards. In FIG. 1, the high-pressure side of the valve disc 4 is therefore located at the bottom and the low-pressure side at the top. There are two locking elements 14 in the shape of balls arranged on the guide in FIG. 1, each of which is pressed and held in a recess 18 by a spring element 16. At the upper end of the projection 10 is a spring 20 that applies an upward force in FIG. 1, thereby reducing the response pressure. The spring 20 comprises a pre-loader 22 by way of which the force generated by the spring can be adjusted. A similar pre-loader 22 is arranged on each spring element 16 such that their force, by means of which the respective locking element 14 is held in the recess 18, can be adjusted. The pre-loader 22 is moved upwards with the valve disc 4 and the projection 6 when the valve disc 4 is brought from the first position into the second position. This allows the upper end of the spring 20 to move upwards as well and the spring 20, which in FIG. 1 is in the tensioned state, i.e. in the compressed state in the present case, relaxes.

In order to bring the valve disc 4 from the first position shown into the second position, which is not depicted, the weight force acting on the valve disc 4 and the projection 10 has to be overcome, less the force applied by the spring 20. In addition, the locking elements 14 have to be displaced radially outwards against the forces generated by the spring elements 16 and thus moved out of the recesses 18.

FIG. 2 depicts the cut through a relief valve according to a further embodiment example of the present invention. It differs to the embodiment example illustrated in FIG. 1 in the closed outlet 24 which, unlike in FIG. 1, is equipped with a further flange 8 in FIG. 2 so that, for example, a pipeline can be connected. Other than that, the embodiments in FIGS. 1 and 2 are structurally identical.

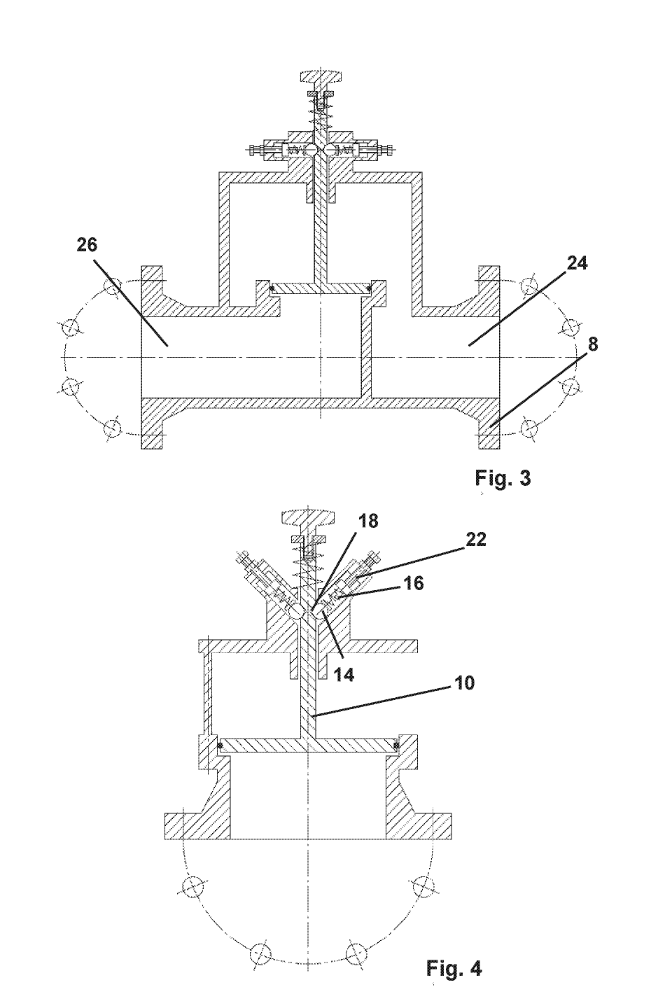

FIG. 3 depicts the cut through a relief valve according to a further embodiment example. It has the same outlet 24 with the flange 8 as the relief valve shown in FIG. 2. Unlike the relief valves shown in the previous figures, an inlet 26 in FIG. 3 is not directed downwards, but to the side.

FIG. 4 depicts an embodiment in which the spring elements 16 push the locking elements 14 into the recesses at an angle other than 90° relative to the projection 10 and hold them in the recesses. Each spring element 16 is again assigned a pre-loader 22, which can be used to vary the force applied by the respective spring element 16.

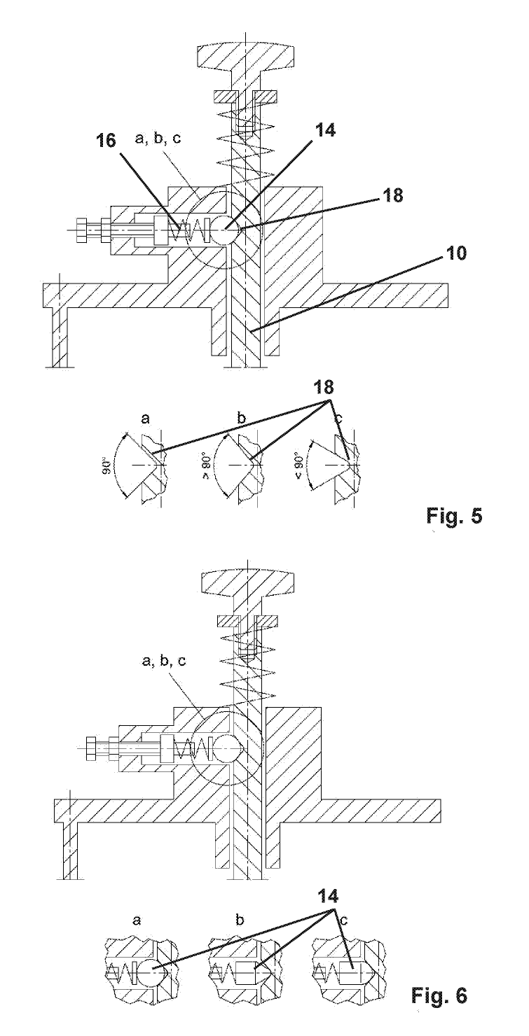

FIG. 5 shows an enlarged section of a sectional view of a relief valve according to a further embodiment example of the present invention. The relief valve comprises a locking element 14, which is pushed into a recess 18 of the projection 10 by a spring element 16. The lower part of FIG. 5 depicts various embodiments of the recess 18 that differ in their opening angles. In the left-hand illustration, the opening angle is 90°, in the middle illustration it is more than 90° and in the right-hand illustration it is less than 90°. This allows the ease with which a locking element 14 can be moved out of the recess 18 to be altered.

The upper section of FIG. 6 shows the section of the sectional view, which corresponds to the upper section of FIG. 5. The lower section depicts various embodiments of a locking element 14. In the left-hand illustration, the locking element 14 is a ball; in the two other illustrations, it is a cylinder with an attached contact area, which features a rounding. This also allows the ease with which the respective locking element 14 can be moved out of the recess 18 to be altered.

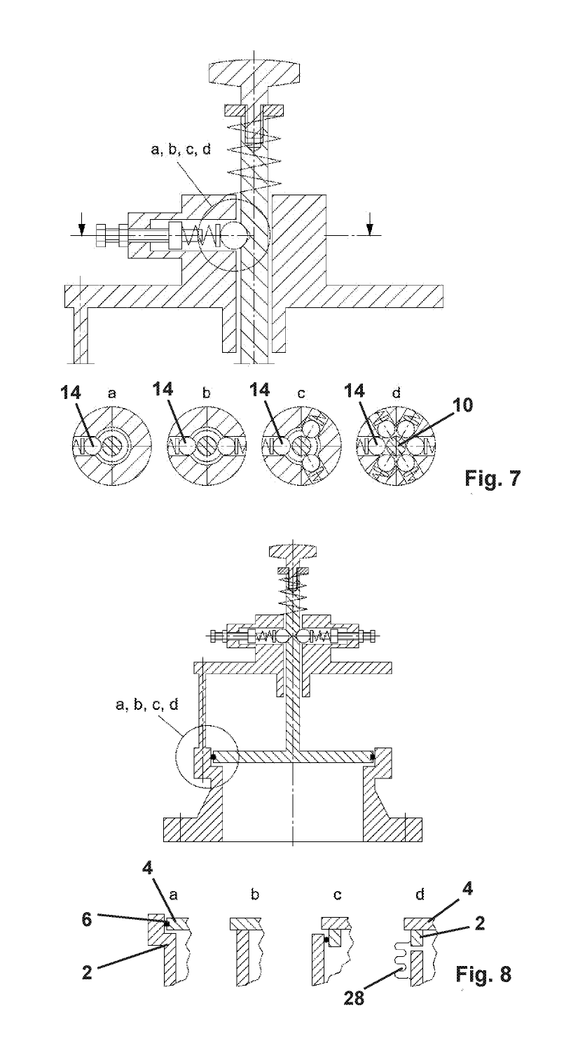

FIG. 7 also shows the same upper section as FIGS. 5 and 6. The lower section of FIG. 7 depicts various configurations of different numbers of locking element 14. From left to right, it shows one (a), two (b), three (c) and six (d) locking elements 14. Each individual locking element 14 is pressed into the respective recess 18 by a spring element 16. It is possible that multiple locking elements 14 are pressed into a common recess 18. For example, the recess 18 may be a partially or fully circumferential groove arranged in the projection 10.

The upper part of FIG. 8 shows FIG. 1. The circle indicates the position at which the elements depicted in the lower part of FIG. 8 can be arranged. The illustrations shown in the lower section, as in FIGS. 5 to 7, also represent alternative embodiments. It is clear that the contact area between the valve disc 4 and the valve seat 2 can be configured with a sealing ring 6 (a) and (c). There is no sealing ring in illustration (b). The valve disc 4 and valve seat 2 are in direct contact with each other. In illustration (d) the valve disc 4 also lies directly on the valve seat 2, which is spring-mounted via a bellows 28.

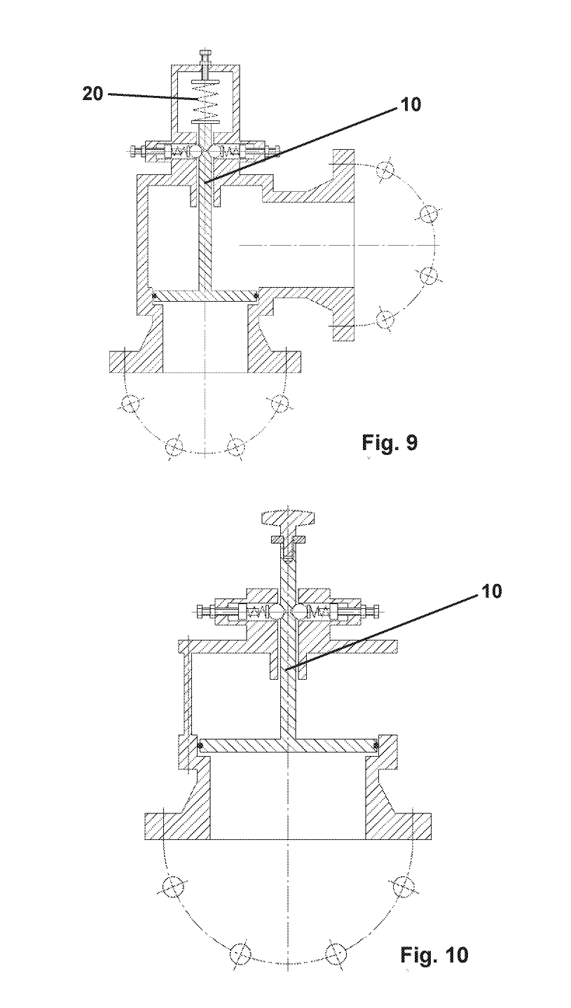

The relief valve depicted in FIG. 9 has the spring 20 at the upper end of the projection 10; however, said spring does not have a pre-loader in this embodiment. Unlike the springs 20 shown in the previous figures, the spring 20 in FIG. 9 exerts a compressive force on the projection 10 and thus on the valve disc 4, thereby increasing the response pressure. In FIG. 10 there is no spring at the upper end of the projection 10.

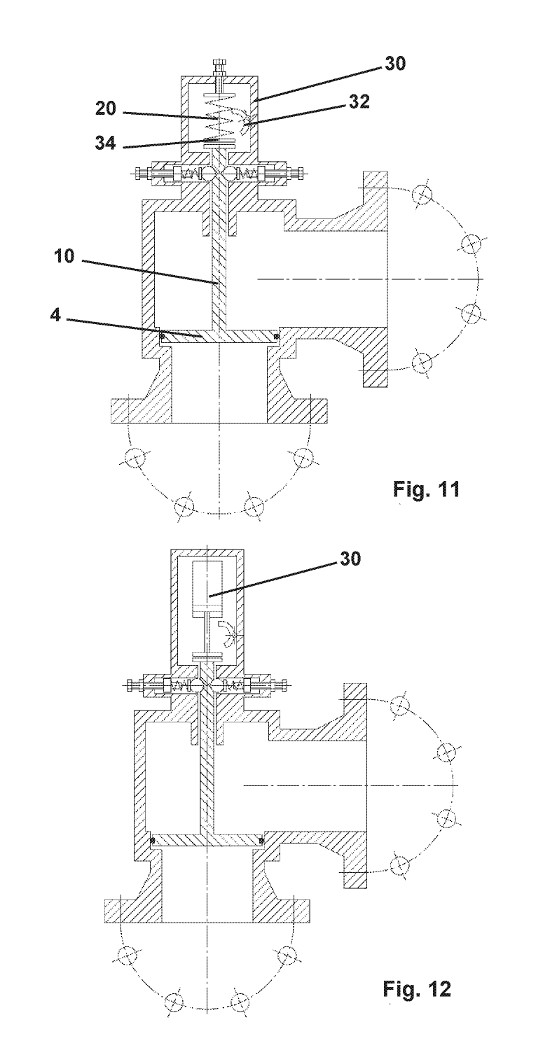

FIG. 11 depicts a sectional view through a relief valve according to a further embodiment example of the present invention. It has an energy store 30. The spring 20 contained within is compressed when the valve disc 4 is displaced upwards out of the depicted first position and into the second position and an actuation element 32, which can also be referred to as a release device, engages under a retaining plate 34 provided for this purpose in this case. As a result, this spring 20 is held in its compressed state and stores potential energy. If the actuation element 32 is actuated, the lower end of the spring 20 is released and the energy stored in the spring 20 acts on the projection 10 and thus on the valve disc 4, which is brought back into the first position.

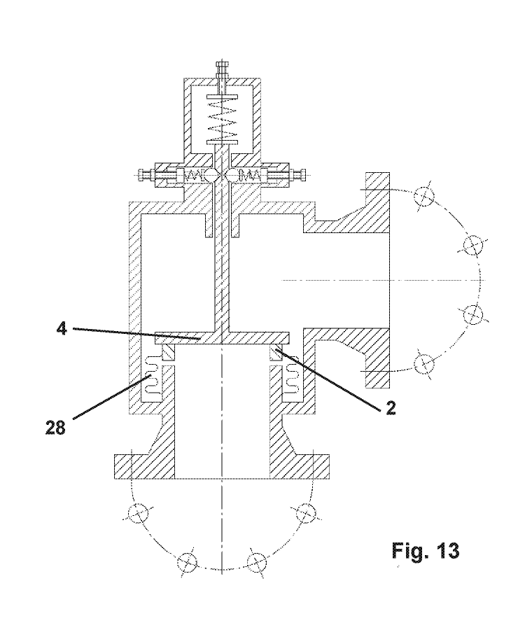

FIG. 12 depicts the cut through a relief valve according to a further embodiment example of the present invention. It corresponds largely to the relief valve shown in FIG. 11, with the difference that the energy store 30 is designed as a pneumatic pressure store. In FIG. 13, the design of the contact area between the valve disc 4 and the valve seat 2 is shown, which is depicted in the right-hand illustration in the lower section of FIG. 8. The valve seat 2 is elastically mounted by the bellows 28.

### REFERENCE LIST

2 valve seat

4 valve disc

6 sealing ring

8 flange

10 projection

12 guide

14 locking element

16 spring element

18 recess

20 spring

22 pre-loader

24 outlet

26 inlet

28 bellows

30 energy store

32 actuation element

34 retaining plate

1. A relief valve, comprising:
a valve seat;
a valve disc moveable between a first position where the valve disc is in contact with the valve sea and the relief valve is closed, and a second position in which the relief valve is open;
at least one locking element;
at least one spring element; and
at least one recess,
wherein the at least one locking element is held in the at least one recess by the at least one spring element when the valve disc is in the first position, and wherein the at least one locking element is moved out of the at least one recess against a force applied by the spring element when the valve disc is brought from the first position into the second position.

2. The relief valve according to claim 1, wherein the at least one locking element is comprised of multiple locking elements, wherein the at least one spring element is comprised of multiple spring elements, and wherein the at least one recess is comprised of multiple recesses.

3. The relief valve according to claim 1, wherein the at least one locking element comprises one or more of a pin, a bolt, and a ball.

4. The relief valve according to claim 1 wherein the at least one locking element is made of a metal or a ceramic.

5. The relief valve according to claim 1 further comprising a projection arranged on the valve disc which is moveable in a guide of the relief valve by the valve disc being brought from the first position into the second position or vice versa.

6. The relief valve according to claim 6 wherein the at least one recess is arranged on the projection and the at least one spring element is arranged on the guide.

7. The relief valve according to claim 1, wherein the at least one recess is a groove in which multiple locking elements of the at least one locking element are held when the valve disc is in the first position.

8. The relief valve according to claim 1 wherein the at least one locking element protrudes into the at least one recess when the at least one locking element is held in the at least one recess.

9. The relief valve according to claim 1 further comprising an energy store where energy is stored when the valve disc is moved from the first position into the second position.

10. The relief valve according to claim 9, further comprising a release device which is configured such that actuation of the release device releases energy stored in the energy store, said released energy then acting on the valve disc and moving it from the second position into the first position.

11. The relief valve according to claim 5 wherein the projection is a valve spindle, a bar, a rod, or a pin.
